(19) United States
(12) Patent Application Publication
(10) Pub. No.: US 2024/0396405 A1
(43) Pub. Date: Nov. 28, 2024

(54) POWER GENERATION DEVICE

(71) Applicant: AISIN CORPORATION, Kariya (JP)

(72) Inventor: Hiroshi ISONO, Kariya-shi (JP)

(73) Assignee: AISIN CORPORATION, Kariya (JP)

(21) Appl. No.: 18/635,849

(22) Filed: Apr. 15, 2024

(30) Foreign Application Priority Data
May 25, 2023 (JP) 2023-086056

(51) Int. Cl. H02K 7/116; F16H 57/021; F16H 57/025; H02K 7/102; H02K 7/108; H02K 7/18

(52) U.S. Cl. CPC H02K 7/116; F16H 57/021; F16H 57/025; H02K 7/102; H02K 7/108; H02K 7/183

(57) ABSTRACT

A power generation device includes a columnar support member, a cylindrical rotation member, a first gear, a second gear, a generator, a step-up gear, and a case. An axis of the support member is a first axis. A direction orthogonal to the first axis is defined as a radial direction. The cylindrical rotation member is supported rotatably relative to the support member. The first gear rotates integrally with the cylindrical rotation member. The second gear is supported rotatably about a second axis. The second axis extends along a direction crossing the first axis. The second gear meshes with the first gear. The step-up gear speeds up rotation of the second gear, and transmits the speeded-up rotation to the generator. The case houses the first gear, the second gear, and the step-up gear. The generator is supported by the case. The case is supported by the support member.

### CROSS REFERENCE TO RELATED APPLICATIONS

This application is based on and claims priority under 35 U.S.C. § 119 to Japanese Patent Application 2023-086056, filed on May 25, 2023, the entire content of which is incorporated herein by reference.

### TECHNICAL FIELD

This disclosure generally relates to a power generation device.

### BACKGROUND DISCUSSION

In JP2017-53304A (Reference 1), a power generation device (1) including a support member (6), a rotation member (2) that is supported in a freely rotatable manner with respect to the support member (6) and rotates by a driving force from a driving force source (8), and a generator (3) that includes a rotor rotating integrally with the rotation member (2) is disclosed. Note that reference signs indicated in parenthesis in the background discussion are reference signs in Reference 1.

In the power generation device (1) in Reference 1, the generator (3) is installed on the ground, and the rotation member (2) extends upward from the generator (3). The support member (6) is formed in a frame shape surrounding the circumference of the rotation member (2) and the generator (3).

In such a configuration, it is necessary to secure a large installation area for the power generation device (1). In addition, since the rotation member (2) and the generator (3) are arranged inside the support member (6), installation work of the power generation device (1) is likely to be complicated.

A need thus exists for a power generation device, which is not susceptible to the drawback mentioned above.

### SUMMARY

A power generation device according to an aspect of this disclosure includes a columnar support member, a cylindrical rotation member, a first gear, a second gear, a generator, a step-up gear, and a case. An axis of the support member is a first axis. A direction orthogonal to the first axis is defined as a radial direction. The cylindrical rotation member is formed in a cylindrical shape surrounding the support member from an outer side in the radial direction, is supported in a freely rotatable manner with respect to the support member, and rotates by a driving force from a driving force source. The first gear rotates integrally with the cylindrical rotation member. The second gear is supported in a freely rotatable manner about a second axis. The second axis extends along a direction that crosses the first axis. The second gear meshes with the first gear. The step-up gear speeds up rotation of the second gear, and transmits the speeded-up rotation to the generator. The case houses the first gear, the second gear, and the step-up gear. The generator is supported by the case. The case includes a first through-hole through which the support member penetrates and a second through-hole through which the support member and the cylindrical rotation member penetrate. The case is supported by the support member.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view of a power generation device according to a first embodiment;

FIG. 2 is a skeleton diagram of the power generation device according to the first embodiment;

FIG. 3 is a cross-sectional view of a brake;

FIG. 4 is a cross-sectional view of a power generation device according to a second embodiment; and

FIG. 5 is a skeleton diagram of the power generation device according to the second embodiment.

### DETAILED DESCRIPTION

### 1. First Embodiment

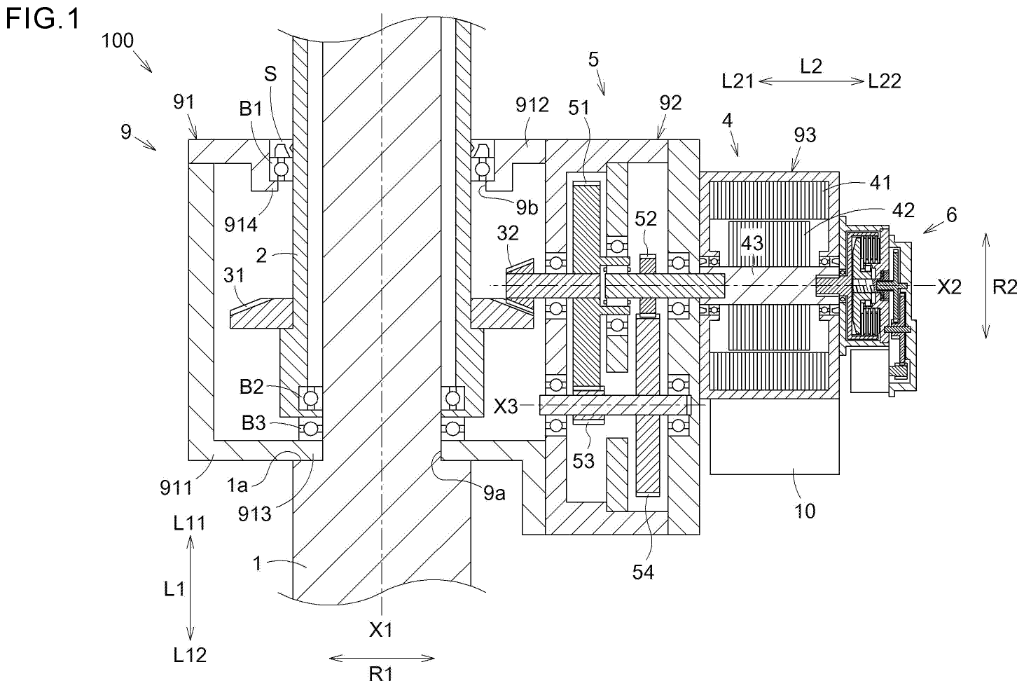

A power generation device 100 according to a first embodiment will be described below with reference to FIGS. 1 to 3.

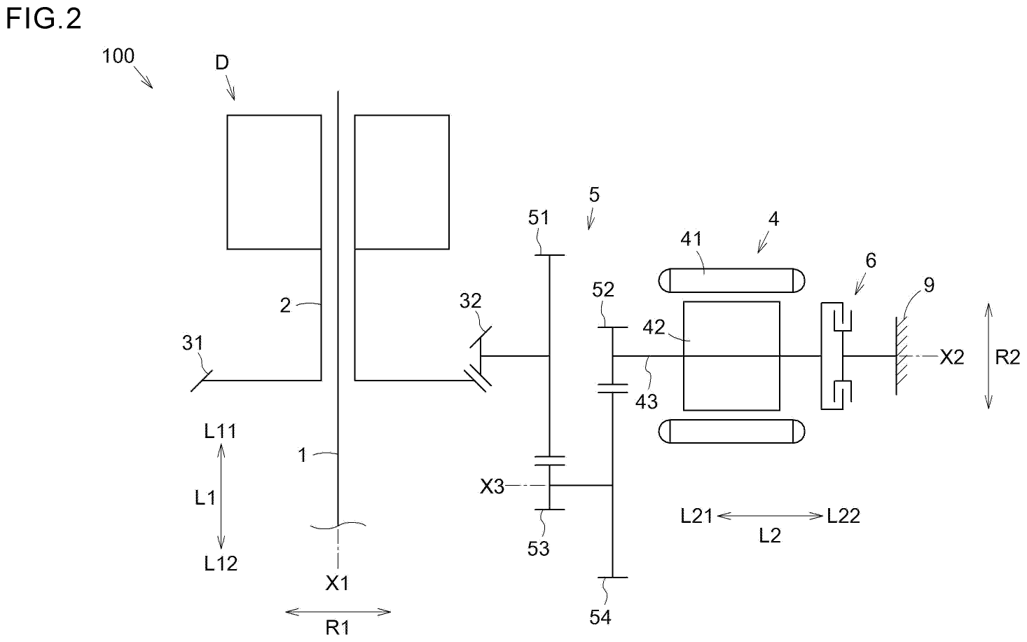

As illustrated in FIGS. 1 and 2, the power generation device 100 includes a support member 1, a cylindrical rotation member 2, a first gear 31, a second gear 32, a generator 4, step-up gears 5, and a case 9 (see FIG. 1).

The support member 1 is formed in a columnar shape (for example, a round columnar shape or a rectangular columnar shape). In the present embodiment, the support member 1 is formed in a round columnar shape. In the following description, a direction orthogonal to a first axis X1 that is an axis of the support member 1 is defined as a “first radial direction R1”. In addition, a direction extending along the first axis X1 is defined as a “first axial direction L1”. One side in the first axial direction L1 is defined as a “first side L11” and the other side in the first axial direction L1 is defined as a “second side L12”. Note that in the present embodiment, the first axial direction L1 is the vertical direction. The first side L11 is the upper side in the vertical direction, and the second side L12 is the lower side in the vertical direction. In the present embodiment, the first radial direction R1 corresponds to a “radial direction”.

An end on the second side L12 of the support member 1 is fixed to a predetermined site (for example, the ground or a sea floor).

The cylindrical rotation member 2 is formed in a cylindrical shape that surrounds the support member 1 from the outer side in the first radial direction R1. In the present embodiment, the cylindrical rotation member 2 is formed in a cylindrical shape having the first axis X1 as an axis. In other words, in the present embodiment, the cylindrical rotation member 2 is arranged coaxially with the support member 1. In addition, in the present embodiment, the cylindrical rotation member 2 is formed in a cylindrical shape in which the ends on both the first side L11 and the second side L12 of the cylindrical rotation member 2 are open. Note that the cylindrical rotation member 2 may be formed in a cylindrical shape (bottomed cylindrical shape) in which an end on one of the first side L11 and the second side L12 of the cylindrical rotation member 2 is closed.

The cylindrical rotation member 2 is supported in a freely rotatable manner with respect to the support member 1. In the present embodiment, the cylindrical rotation member 2 is supported in a freely rotatable manner with respect to the support member 1 via a second bearing B2 that is arranged between an inner circumferential surface of the cylindrical rotation member 2 and an outer circumferential surface of the support member 1 in the first radial direction R1. The second bearing B2 is a radial bearing that supports the cylindrical rotation member 2 in the first radial direction R1 in a freely rotatable manner with respect to the support member 1.

In addition, the cylindrical rotation member 2 rotates by a driving force from a driving force source D (see FIG. 2). The driving force source D is configured to convert kinetic energy of a fluid to rotational energy. For example, as the driving force source D, a wind turbine, a hydraulic turbine, a steam turbine, a gas turbine, or the like can be used. In other words, the power generation device 100 can be used in wind power generation, hydroelectric power generation, thermal power generation, or the like.

The first gear 31 is a gear that rotates integrally with the cylindrical rotation member 2. In the present embodiment, the first gear 31 is connected to the cylindrical rotation member 2 while projecting outward in the first radial direction R1 from an outer circumferential surface of the cylindrical rotation member 2. In addition, the first gear 31 is supported in a freely rotatable manner about the first axis X1.

The second gear 32 is a gear that meshes with the first gear 31. In the present embodiment, the second gear 32 is formed to have a smaller diameter than the first gear 31. Therefore, in the present embodiment, rotation transmitted to the first gear 31 is speeded up between the first gear 31 and the second gear 32.

The second gear 32 is supported in a freely rotatable manner about a second axis X2 that extends along a direction crossing the first axis X1. In other words, the second gear 32 and the first gear 31 are bevel gears, crossed helical gears, or the like. In the present embodiment, the second axis X2 is arranged to be orthogonal to the first axis X1. In the following description, a direction orthogonal to the second axis X2 is defined as a “second radial direction R2”. In addition, a direction extending along the second axis X2 is defined as a “second axial direction L2”. One side in the second axial direction L2 is defined as a “third side L21” and the other side in the second axial direction L2 is defined as a “fourth side L22”.

The generator 4 is configured to generate electric power by a driving force transmitted from the cylindrical rotation member 2 side. The generator 4 is supported by the case 9.

In the present embodiment, the generator 4 is a rotary electric machine including a stator 41 and a rotor 42. The rotary electric machine is electrically connected to a power storage device (illustration is omitted), such as a battery and a capacitor, in such a way as to transfer power with the power storage device. The rotary electric machine has a function as a motor that generates motive power upon receiving supply of electric power and a function as a generator that generates electric power upon receiving supply of motive power. Therefore, in the present embodiment, the generator 4 not only generates electric power by a driving force transmitted from the cylindrical rotation member 2 side but also performs power running upon receiving supply of electric power from the power storage device and transmits a driving force to the driving force source D at the time of activation or the like of the power generation device 100.

The stator 41 and the rotor 42 are arranged on the second axis X2. The stator 41 is fixed to a non-rotational member (herein, the case 9). The rotor 42 is supported in a freely rotatable manner with respect to the stator 41. In the present embodiment, the rotor 42 is arranged on the inner side in the second radial direction R2 with respect to the stator 41.

In the present embodiment, the rotor 42 is connected to a rotor shaft 43 in such a manner as to rotate integrally with the rotor shaft 43. The rotor shaft 43 is arranged on the second axis X2. The rotor shaft 43 is formed to extend along the second axial direction L2.

The step-up gears 5 are configured to speed up rotation of the second gear 32 and transmit the speeded-up rotation to the generator 4. In the present embodiment, the step-up gears 5 include a third gear 51, a fourth gear 52, a fifth gear 53, and a sixth gear 54.

The third gear 51 is a gear to which a driving force from the second gear 32 is transmitted. The third gear 51 is arranged on the second axis X2. In the present embodiment, the third gear 51 is coupled to the second gear 32 in such a manner as to rotate integrally with the second gear 32.

The fourth gear 52 is a gear that rotates integrally with the rotor 42 of the generator 4. In the present embodiment, the fourth gear 52 is arranged on the second axis X2. The fourth gear 52 is coupled to the rotor shaft 43 in such a manner as to rotate integrally with the rotor shaft 43. In the present embodiment, the fourth gear 52 is formed to have a smaller diameter than the third gear 51. In addition, the fourth gear 52 is arranged on the third side L21 of the rotor 42 and on the fourth side L22 of the third gear 51.

The fifth gear 53 is a gear that meshes with the third gear 51. In the present embodiment, the fifth gear 53 is formed to have a smaller diameter than the third gear 51. In addition, the fifth gear 53 is arranged on a third axis X3 that is different from the first axis X1 and the second axis X2. In the present embodiment, the third axis X3 is arranged in parallel with the second axis X2.

The sixth gear 54 is a gear that meshes with the fourth gear 52. The sixth gear 54 is coupled to the fifth gear 53 in such a manner as to rotate integrally with the fifth gear 53. The sixth gear 54 is arranged on the third axis X3. In the present embodiment, the sixth gear 54 is formed to have a larger diameter than the fourth gear 52 and the fifth gear 53.

The number of teeth of the fifth gear 53 is smaller than the number of teeth of the third gear 51. The number of teeth of the fourth gear 52 is smaller than the number of teeth of the sixth gear 54, which rotates integrally with the fifth gear 53. Therefore, rotation transmitted from the second gear 32 to the third gear 51 is speeded up between the third gear 51 and the fifth gear 53 and transmitted to the sixth gear 54. Rotation of the sixth gear 54 is speeded up between the sixth gear 54 and the fourth gear 52 and is transmitted to the rotor 42.

As illustrated in FIG. 1, the case 9 is formed to house the first gear 31, the second gear 32, and the step-up gears 5. In the present embodiment, the case 9 includes a first housing portion 91 that houses the first gear 31 and the second gear 32, a second housing portion 92 that houses the step-up gears 5, and a third housing portion 93 that houses the generator 4.

The case 9 includes a first through-hole 9a and a second through-hole 9b. The first through-hole 9a is a through-hole through which the support member 1 penetrates. The first through-hole 9a is arranged on the first axis X1. The second through-hole 9b is a through-hole through which the support member 1 and the cylindrical rotation member 2 penetrate. In the present embodiment, the second through-hole 9b is arranged on the first axis X1. In other words, in the present embodiment, the second through-hole 9b is arranged coaxially with the first through-hole 9a.

In the present embodiment, the first housing portion 91 includes a first wall portion 911 and a second wall portion 912 that are formed to extend along the first radial direction R1. The first wall portion 911 includes a first through-hole forming portion 913 that is a portion of the case 9 in which the first through-hole 9a is formed. The second wall portion 912 includes a second through-hole forming portion 914 that is a portion of the case 9 in which the second through-hole 9b is formed. In the present embodiment, the first wall portion 911 is arranged on the second side L12 of the second wall portion 912. Therefore, in the present embodiment, the first through-hole 9a is arranged on the second side L12 of the second through-hole 9b.

In the present embodiment, the cylindrical rotation member 2 is arranged to project from the second through-hole 9b to the first side L11. To an end on the first side L11 of the cylindrical rotation member 2, the driving force source D is connected (see FIG. 2).

In the present embodiment, the support member 1 includes a stepped surface 1a that faces the first side L11. The first through-hole forming portion 913 is arranged to come into contact with the stepped surface 1a from the first side L11.

In the present embodiment, the support member 1 is fitted into the first through-hole 9a. In other words, in the present embodiment, the outer circumferential surface of the support member 1 and an inner circumferential surface of the first through-hole 9a are formed to come into close contact with each other. In this way, the case 9 is supported by the support member 1.

In the present embodiment, a first bearing B1 is arranged between an inner circumferential surface of the second through-hole 9b and the outer circumferential surface of the cylindrical rotation member 2 in the first radial direction R1. The first bearing B1 is a radial bearing that supports the cylindrical rotation member 2 in the first radial direction R1 in a freely rotatable manner with respect to the second through-hole forming portion 914 of the case 9. In the present embodiment, the first bearing B1 corresponds to a “bearing”.

In addition, in the present embodiment, a sealing member S that seals a space between the inner circumferential surface of the second through-hole 9b and the outer circumferential surface of the cylindrical rotation member 2 is installed on the first side L11 with respect to the first bearing B1.

In the present embodiment, a third bearing B3 is arranged between a surface of the cylindrical rotation member 2 that faces the second side L12 and a surface of the first through-hole forming portion 913 of the case 9 that faces the first side L11 in the first axial direction L1. The third bearing B3 is a thrust bearing that supports the cylindrical rotation member 2 in the first axial direction L1 in a freely rotatable manner with respect to the first through-hole forming portion 913 of the case 9.

As described above, the power generation device 100 includes the columnar support member 1, the cylindrical rotation member 2, the first gear 31, the second gear 32, the generator 4, the step-up gears 5, and the case 9. The cylindrical rotation member 2 is formed in a cylindrical shape surrounding the support member 1 from the outer side in the first radial direction R1, is supported in a freely rotatable manner with respect to the support member 1, and rotates by a driving force from the driving force source D. The first gear 31 rotates integrally with the cylindrical rotation member 2. The second gear 32 is supported in a freely rotatable manner about the second axis X2. The second axis X2 extends along a direction that crosses the first axis X1. The first axis X1 is an axis of the support member 1. The second gear 32 meshes with the first gear 31. The step-up gears 5 speed up rotation of the second gear 32, and transmits the speeded-up rotation to the generator 4. The case 9 houses the first gear 31, the second gear 32, and the step-up gears 5. The generator 4 is supported by the case 9. The case 9 includes the first through-hole 9a through which the support member 1 penetrates and the second through-hole 9b through which the support member 1 and the cylindrical rotation member 2 penetrate. The case 9 is supported by the support member 1.

According to this configuration, the first gear 31, the second gear 32, and the step-up gears 5 are housed in the case 9, and the generator 4 is supported by the case 9. The case 9 is supported by the columnar support member 1. Since because of this configuration, it is not necessary to install a member to support the first gear 31, the second gear 32, the step-up gears 5, and the generator 4, separately from the support member 1, installation area of the power generation device 100 can be easily kept small.

In addition, attaching the case 9 to the support member 1 enables the first gear 31, the second gear 32, the step-up gears 5, and the generator 4 to be supported with respect to the support member 1. Because of this capability, simplification of installation work of the power generation device 100 can be easily achieved.

In addition, in the present embodiment, the support member 1 includes the stepped surface 1a that faces the first side L11. The first side L11 is one side in the first axial direction L1.

A portion of the case 9 in which the first through-hole 9a is formed is arranged to come into contact with the stepped surface 1a from the first side L11.

The support member 1 is fitted into the first through-hole 9a.

The first bearing B1 is arranged between the inner circumferential surface of the second through-hole 9b and the outer circumferential surface of the cylindrical rotation member 2 in the first radial direction R1.

According to this configuration, the case 9 and the generator 4 supported by the case 9 can be appropriately supported by the support member 1 while the columnar support member 1 penetrates through the first through-hole 9a and the second through-hole 9b of the case 9.

In addition, according to the present configuration, the cylindrical rotation member 2 can be supported in a freely rotatable manner by the support member 1 and the case 9 while the cylindrical rotation member 2 penetrates through the second through-hole 9b of the case 9.

As illustrated in FIG. 1, in the present embodiment, the power generation device 100 further includes an inverter 10 that controls the generator 4. The inverter 10 is arranged to overlap the sixth gear 54 in a second axial direction view along the second axial direction L2. In the present embodiment, the inverter 10 is arranged to also overlap the fifth gear 53 in addition to the sixth gear 54 in the second axial direction view along the second axial direction L2. In addition, the inverter 10 is arranged to overlap both the stator 41 and the rotor 42 in a second radial direction view along the second radial direction R2. As used herein, two element “overlapping each other in a specific direction view” with regard to an arrangement of the two element means that when a virtual straight line that is parallel with the view direction is moved in respective directions orthogonal to the virtual straight line, at least some region in which the virtual straight line crosses both the two elements exists.

As described above, in the present embodiment, the power generation device 100 further includes the inverter 10 that controls the generator 4.

The generator 4 includes the rotor 42 that is arranged on the second axis X2.

The step-up gears 5 include the third gear 51 that is arranged on the second axis X2 and to which a driving force from the second gear 32 is transmitted, the fourth gear 52 that rotates integrally with the rotor 42, the fifth gear 53 that meshes with the third gear 51, and the sixth gear 54 that rotates integrally with the fifth gear 53 and meshes with the fourth gear 52.

The inverter 10 is arranged to overlap the sixth gear 54 in the second axial direction view along the second axial direction L2.

According to this configuration, the rotor 42 of the generator 4 and the second gear 32 are arranged coaxially. Since because of this configuration, the number of axes can be kept small compared with a configuration in which the rotor 42 of the generator 4 and the second gear 32 are arranged on separate axes, miniaturization of the power generation device 100 can be easily achieved.

In addition, according to the present configuration, the inverter 10 is arranged to overlap the sixth gear 54, which is arranged on a separate axis from the second axis X2, in the second axial direction view. Because of this configuration, miniaturization of the power generation device 100 can be easily achieved compared with a configuration in which the inverter 10 is arranged not to overlap the sixth gear 54 in the second axial direction view.

As illustrated in FIG. 1, in the present embodiment, the power generation device 100 further includes a brake 6 to decelerate rotation of the rotor 42. The brake 6 is a friction engagement-type engagement device. Herein, an engagement device of friction engagement type is configured to be able to control a state of engagement (an engaged state or a released state) according to engagement pressure between a pair of friction engagement members. In the engagement device of friction engagement type, the engaged state includes a “directly engaged state” and a “slip-engaged state”. The directly engaged state is a state in which a pair of friction engagement members are engaged with each other without differential rotation. In addition, the slip-engaged state is a state in which the pair of friction engagement members are engaged with each other with differential rotation.

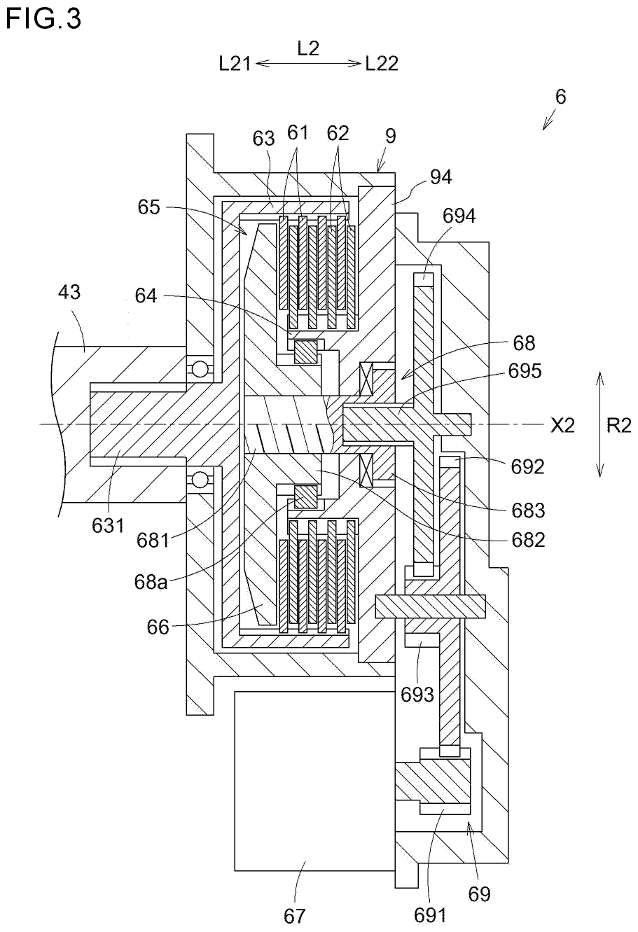

As illustrated in FIG. 3, the brake 6 includes first friction engagement members 61, second friction engagement members 62, a first support member 63, a second support member 64, and a pressing device 65.

The first friction engagement members 61 and the second friction engagement members 62 are arranged on the second axis X2. The first friction engagement members 61 and the second friction engagement members 62 are arranged to face each other in the second axial direction L2. In the present embodiment, a plurality of first friction engagement members 61 and a plurality of second friction engagement members 62 are installed and are alternately arranged along the second axial direction L2. One and the other of the first friction engagement members 61 and the second friction engagement members 62 can be set as friction plates and separate plates, respectively.

The first support member 63 is a member that supports the first friction engagement members 61 while restricting relative rotation of the first friction engagement members 61. In the present embodiment, the first support member 63 is formed in a cylindrical shape having the second axis X2 as an axis. The first support member 63 supports outer circumferential portions of the first friction engagement members 61.

The first support member 63 is coupled to the rotor 42 in such a manner as to rotate integrally with the rotor 42. In the present embodiment, the first support member 63 is coupled to the rotor shaft 43 in such a manner as to rotate integrally with the rotor shaft 43 via a coupling shaft 631. The coupling shaft 631 is arranged on the second axis X2. The coupling shaft 631 is formed to extend along the second axial direction L2.

The second support member 64 is a member that supports the second friction engagement members 62 while restricting relative rotation of the second friction engagement members 62. The second support member 64 is fixed to the case 9. In the present embodiment, the second support member 64 is formed in a cylindrical shape having the second axis X2 as an axis. The second support member 64 supports inner circumferential portions of the second friction engagement members 62. In addition, in the present embodiment, the second support member 64 is fixed to a support wall portion 94 that the case 9 includes. The support wall portion 94 is formed to extend along the second radial direction R2. The support wall portion 94 is arranged to cover the first friction engagement members 61 and the second friction engagement members 62 from the fourth side L22. In the example illustrated in FIG. 3, the second support member 64 is integrally formed with the support wall portion 94 in such a manner as to project to the third side L21 from the support wall portion 94.

The pressing device 65 is a device that presses the first friction engagement members 61 and the second friction engagement members 62 in the second axial direction L2. In the present embodiment, the pressing device 65 includes a pressing member 66 that exerts a pressing force on the first friction engagement members 61 and the second friction engagement members 62, a drive motor 67, and a screw-type linear motion conversion mechanism 68 that converts rotational driving force of the drive motor 67 to driving force in the second axial direction L2 and transmits the converted driving force to the pressing member 66.

The pressing member 66 is arranged at a position at which the pressing member 66 overlaps the first friction engagement members 61 and the second friction engagement members 62 in the second axial direction view along the second axial direction L2. In the present embodiment, the pressing member 66 is arranged on the inner side in the second radial direction R2 with respect to the first support member 63 and on the fourth side L22 with respect to the coupling shaft 631. In addition, in the present embodiment, the pressing member 66 is formed in a plate shape extending along the second radial direction R2.

The drive motor 67 is a motor that generates a rotational driving force to drive the pressing member 66. In the present embodiment, the drive motor 67 is arranged at a position located on the outer side in the second radial direction R2 with respect to the first support member 63 and overlapping the first support member 63 in the second radial direction view along the second radial direction R2.

In the present embodiment, the linear motion conversion mechanism 68 includes a threaded shaft member 681, a nut member 682, a coupling member 683, and a speed reduction mechanism 69.

The threaded shaft member 681 is formed to extend along the second axial direction L2. The nut member 682 is formed in an annular shape that covers the threaded shaft member 681 from the outer side in the second radial direction R2. The threaded shaft member 681 and the nut member 682 are configured to be screwed to each other. Specifically, an external thread is formed on an outer circumferential portion of the threaded shaft member 681, and an internal thread that is screwed onto the external thread of the threaded shaft member 681 is formed on an inner circumferential portion of the nut member 682. Therefore, by the threaded shaft member 681 rotating, the nut member 682 performs linear motion along the second axial direction L2 according to the rotational direction of the threaded shaft member 681 and directions of the external thread and the internal thread. In the present embodiment, the threaded shaft member 681 and the nut member 682 are arranged on the second axis X2.

The nut member 682 is supported in a relatively non-rotatable manner with respect to the case 9 and in a freely movable manner in the second axial direction L2. In the present embodiment, the nut member 682 is arranged on the inner side in the second radial direction R2 with respect to the second support member 64 fixed to the case 9. The nut member 682 is coupled to the second support member 64 in a relatively non-rotatable manner and in a freely relatively movable manner in the second axial direction L2 with respect to the second support member 64 via an annular detent member 68a arranged between the nut member 682 and the second support member 64 in the second radial direction R2. In the example illustrated in FIG. 3, on an outer circumferential portion of the nut member 682, a plurality of spline teeth extending in the second axial direction L2 are formed in a distributed manner in the circumferential direction. On an inner circumferential portion of the detent member 68a, a plurality of spline teeth that are engaged with the plurality of spline teeth formed on the outer circumferential portion of the nut member 682 are formed in a distributed manner in the circumferential direction in such a manner as to extend in the second axial direction L2. In addition, on an inner circumferential portion of the second support member 64, a plurality of spline teeth extending in the second axial direction L2 are formed in a distributed manner in the circumferential direction. On an outer circumferential portion of the detent member 68a, a plurality of spline teeth that are engaged with the plurality of spline teeth formed on the inner circumferential portion of the second support member 64 are formed in a distributed manner in the circumferential direction in such a way as to extend in the second axial direction L2.

In addition, the nut member 682 is connected to the pressing member 66 in such a manner as to move integrally with the pressing member 66 in the second axial direction L2. In the example illustrated in FIG. 3, the nut member 682 is integrally formed with the pressing member 66. Therefore, in association with rotation of the threaded shaft member 681, the pressing member 66 moves in the second axial direction L2 via the nut member 682.

The coupling member 683 couples the threaded shaft member 681 to the speed reduction mechanism 69. In the present embodiment, the coupling member 683 is formed in a cylindrical shape extending from the threaded shaft member 681 to the fourth side L22.

The speed reduction mechanism 69 is configured to reduce speed of rotation of the drive motor 67. In the present embodiment, the speed reduction mechanism 69 includes a first reduction gear 691, a second reduction gear 692, a third reduction gear 693, and a fourth reduction gear 694.

The first reduction gear 691 is coupled to an output shaft of the drive motor 67 in such a manner as to rotate integrally with the output shaft of the drive motor 67. In the present embodiment, the first reduction gear 691 is arranged on the fourth side L22 with respect to the drive motor 67.

The second reduction gear 692 meshes with the first reduction gear 691. The second reduction gear 692 is formed to have a larger diameter than the first reduction gear 691.

The third reduction gear 693 is coupled to the second reduction gear 692 in such a manner as to rotate integrally with the second reduction gear 692. The third reduction gear 693 is formed to have a smaller diameter than the second reduction gear 692. In the present embodiment, the third reduction gear 693 is arranged on the third side L21 with respect to the second reduction gear 692.

The fourth reduction gear 694 meshes with the third reduction gear 693. The fourth reduction gear 694 is formed to have a larger diameter than the third reduction gear 693. In the present embodiment, the fourth reduction gear 694 is arranged on the second axis X2.

The number of teeth of the second reduction gear 692 is larger than the number of teeth of the first reduction gear 691. The number of teeth of the fourth reduction gear 694 is larger than the number of teeth of the third reduction gear 693, which rotates integrally with the second reduction gear 692. Therefore, rotation transmitted from the drive motor 67 to the first reduction gear 691 is subjected to speed reduction between the first reduction gear 691 and the second reduction gear 692 and is transmitted to the third reduction gear 693. Rotation of the third reduction gear 693 is subjected to speed reduction between the third reduction gear 693 and the fourth reduction gear 694.

In the present embodiment, the coupling member 683 couples the threaded shaft member 681 to the fourth reduction gear 694. Specifically, a gear coupling portion 695 that extends from the fourth reduction gear 694 to the third side L21 is connected to the coupling member 683 in such a manner as to integrally rotate with the coupling member 683 while being arranged on the inner side in the second radial direction R2 with respect to the coupling member 683. In the example illustrated in FIG. 3, on an inner circumferential portion of the coupling member 683, a plurality of spline teeth extending in the second axial direction L2 are formed in a distributed manner in the circumferential direction. On an outer circumferential portion of the gear coupling portion 695, a plurality of spline teeth that are engaged with the plurality of spline teeth formed on the inner circumferential portion of the coupling member 683 are formed in a distributed manner in the circumferential direction in such a way as to extend in the second axial direction L2.

In the present embodiment, the linear motion conversion mechanism 68 is arranged at a position located on the inner side in the second radial direction R2 with respect to the first friction engagement members 61 and the second friction engagement members 62 and overlapping the first friction engagement members 61 and the second friction engagement members 62 in the second radial direction view along the second radial direction R2. In the example illustrated in FIG. 3, the threaded shaft member 681, the nut member 682, and the coupling member 683 of the linear motion conversion mechanism 68 are arranged at positions located on the inner side in the second radial direction R2 with respect to the first friction engagement members 61 and the second friction engagement members 62 and overlapping the first friction engagement members 61 and the second friction engagement members 62 in the second radial direction view along the second radial direction R2.

When in the brake 6, the pressing member 66 moves to the fourth side L22 and presses the first friction engagement members 61 and the second friction engagement members 62, movement of the first friction engagement members 61 and the second friction engagement members 62 to the fourth side L22 is restricted by the support wall portion 94 of the case 9. In association with the movement of the pressing member 66 to the fourth side L22, the first friction engagement members 61 and the second friction engagement members 62 are engaged with each other and the brake 6 is brought into an engaged state.

Bringing the brake 6 into the slip-engaged state in this manner enables rotation of the rotor 42 to be decelerated. Further, bringing the brake 6 into the directly engaged state enables the rotation of the rotor 42 to be stopped. Because of this configuration, when power generation by the generator 4 is to be suspended, the rotation of the rotor 42 can be appropriately decelerated and the power generation by the generator 4 can be suspended by bringing the brake 6 into the engaged state. Therefore, when, for example, a wind turbine is used as the driving force source D, damage to the wind turbine can be prevented by causing rotation of the wind turbine to be suspended when strong wind blows.

On the other hand, when the pressing member 66 moves to the third side L21 and pressing of the first friction engagement members 61 and the second friction engagement members 62 by the pressing member 66 is canceled, the first friction engagement members 61 and the second friction engagement members 62 are brought into a state of being relatively rotatable without differential rotation with respect to each other and the brake 6 is brought into a released state. When the brake 6 is brought into the released state, the rotor 42 becomes rotatable without being decelerated.

### 2. Second Embodiment

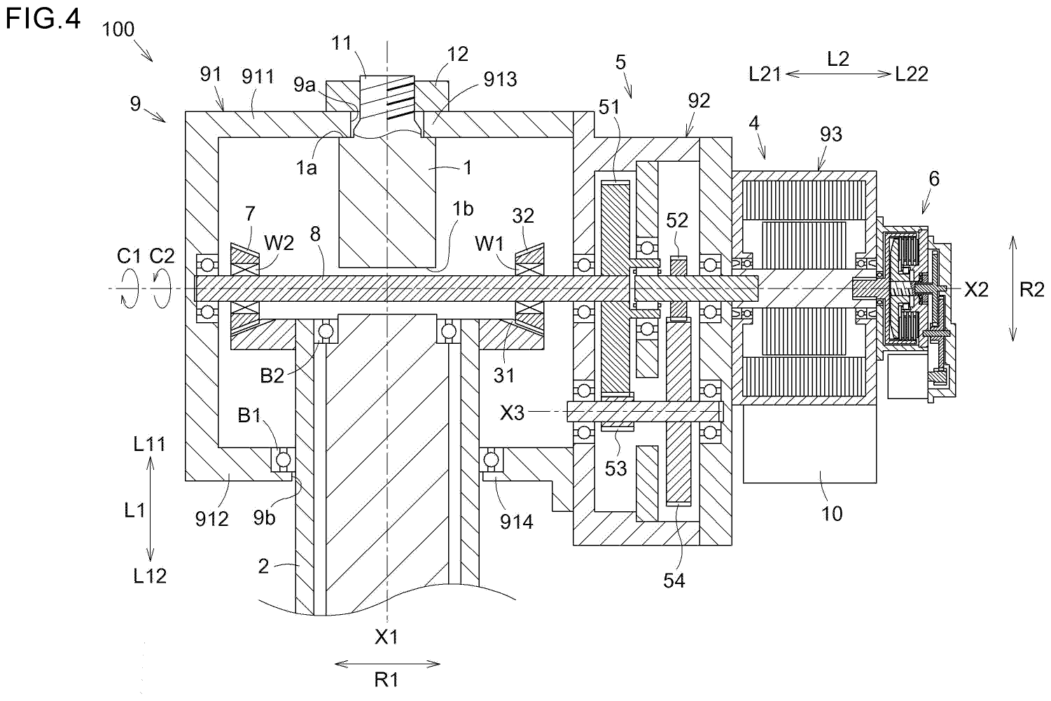

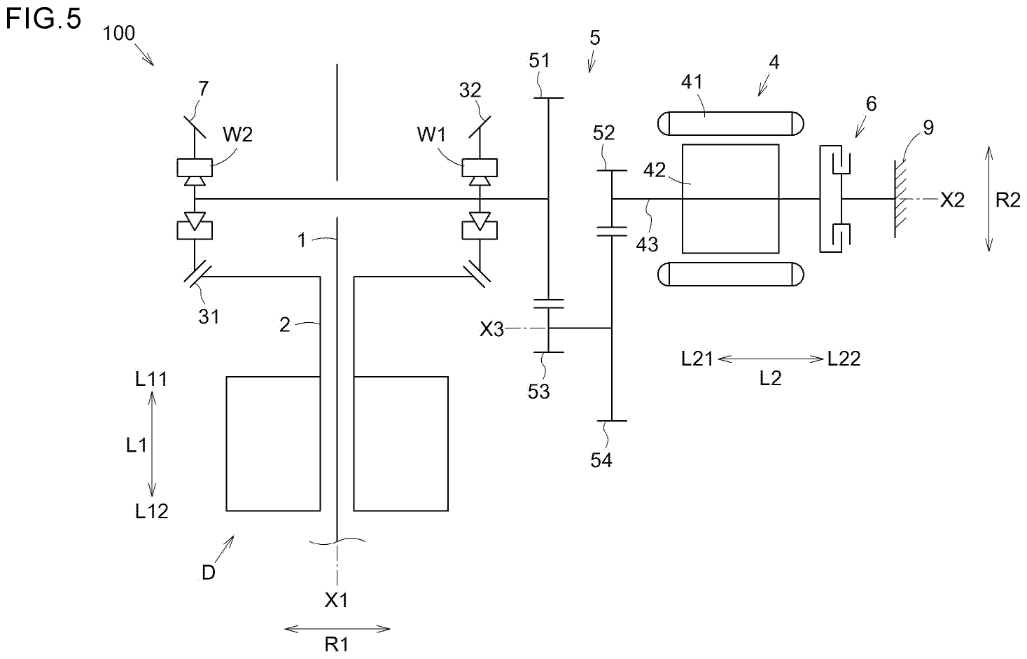

A power generation device 100 according to a second embodiment will be described below with reference to FIGS. 4 and 5. In the present embodiment, a configuration of a power transmission path between a first gear 31 and a step-up gears 5 is different from the configuration of a power transmission path in the above-described first embodiment. The following description will be made focusing on differences from the above-described first embodiment. Note that it is assumed that points that are not particularly described are the same as in the above-described first embodiment.

As illustrated in FIGS. 4 and 5, in the present embodiment, the power generation device 100 further includes a seventh gear 7, a transmission shaft 8, a first one-way clutch W1, and a second one-way clutch W2.

The seventh gear 7 is a gear that meshes with the first gear 31. The seventh gear 7 is arranged on the opposite side to a second gear 32 with a support member 1 interposed therebetween on a second axis X2. In other words, the second gear 32 is arranged on a fourth side L22 with respect to the support member 1, and the seventh gear 7 is arranged on a third side L21 with respect to the support member 1. The seventh gear 7 is supported in a freely rotatable manner about the second axis X2. In other words, the seventh gear 7 is, as with the second gear 32, a bevel gear, a crossed helical gear, or the like.

The transmission shaft 8 is drivingly connected to a step-up gears 5. In the present embodiment, the transmission shaft 8 is connected to a third gear 51 of the step-up gears 5 in such a manner as to rotate integrally with the third gear 51. As used herein, “being drivingly connected” means a state in which two rotational elements are connected to each other in such a manner that driving force can be transmitted therebetween, and includes a state in which the two rotational elements are connected to each other in such a manner as to integrally rotate or a state in which the two rotational elements are coupled to each other in such a manner that driving force can be transmitted therebetween via one or two or more transmission members. Examples of such a transmission member include various types of members that transmits rotation at the same speed or by changing speed, such as a shaft, a gear mechanism, a belt, and a chain. Note that examples of the transmission member may include an engagement device that selectively transmits rotation and driving force, such as a friction engagement device and a gearing type engagement device.

The transmission shaft 8 is formed to extend along the second axial direction L2. The transmission shaft 8 is arranged on the second axis X2. The transmission shaft 8 is arranged to penetrate through the second gear 32 and the seventh gear 7. In the present embodiment, the support member 1 includes a through-hole 1b that penetrates through the support member 1 in the second axial direction L2. The transmission shaft 8 is arranged to penetrate through the through-hole 1b.

In the following description, one side and the other side of rotational directions about the second axis X2 are defined as a “first rotational side C1” and a “second rotational side C2”, respectively.

The first one-way clutch W1 is arranged between the second gear 32 and the transmission shaft 8. The first one-way clutch W1 is configured to allow relative rotation to the first rotational side C1 and restrict relative rotation to the second rotational side C2 of the second gear 32 with respect to the transmission shaft 8.

The second one-way clutch W2 is arranged between the seventh gear 7 and the transmission shaft 8. The second one-way clutch W2 is configured to allow relative rotation to the first rotational side C1 and restrict relative rotation to the second rotational side C2 of the seventh gear 7 with respect to the transmission shaft 8.

In the present embodiment, when a cylindrical rotation member 2 rotates to one side of the rotational directions, the second gear 32 rotates to the first rotational side C1 and the seventh gear 7 rotates to the second rotational side C2. On this occasion, relative rotation of the second gear 32 with respect to the transmission shaft 8 to the first rotational side C1 is allowed by the first one-way clutch W1, and relative rotation of the seventh gear 7 with respect to the transmission shaft 8 to the second rotational side C2 is restricted by the second one-way clutch W2. As a result, the transmission shaft 8 rotates to the second rotational side C2.

In contrast, when the cylindrical rotation member 2 rotates to the other side of the rotational directions, the second gear 32 rotates to the second rotational side C2 and the seventh gear 7 rotates to the first rotational side C1. On this occasion, relative rotation of the second gear 32 with respect to the transmission shaft 8 to the second rotational side C2 is restricted by the first one-way clutch W1, and relative rotation of the seventh gear 7 with respect to the transmission shaft 8 to the first rotational side C1 is allowed by the second one-way clutch W2. As a result, the transmission shaft 8 rotates to the second rotational side C2.

As described above, in the present embodiment, the power generation device 100 further includes the seventh gear 7, the transmission shaft 8, the first one-way clutch W1, and the second one-way clutch W2. The seventh gear 7 is arranged on the opposite side to the second gear 32 with the support member 1 interposed therebetween on the second axis X2, is supported in a freely rotatable manner about the second axis X2, and meshes with the first gear 31. The transmission shaft 8 is arranged to penetrate through the second gear 32 and the seventh gear 7 and is drivingly connected to the step-up gears 5 The first one-way clutch W1 is arranged between the second gear 32 and the transmission shaft 8 and allows relative rotation to the first rotational side C1 and restricts relative rotation to the second rotational side C2 of the second gear 32 with respect to the transmission shaft 8. The second one-way clutch W2 is arranged between the seventh gear 7 and the transmission shaft 8 and allows relative rotation to the first rotational side C1 and restricts relative rotation to the second rotational side C2 of the seventh gear 7 with respect to the transmission shaft 8.

According to this configuration, even when the cylindrical rotation member 2 rotates in any one of the directions, a driving force can be transmitted to the transmission shaft 8 from one of the second gear 32 and the seventh gear 7 in such a way that the transmission shaft 8 rotates in one direction. Because of this configuration, a rotor 42 of a generator 4 can be rotated in one direction regardless of the rotational direction of the cylindrical rotation member 2. Therefore, power generation can be efficiently performed.

As illustrated in FIG. 4, in the present embodiment, a first wall portion 911 is arranged on a first side L11 of a second wall portion 912. Therefore, in the present embodiment, a first through-hole 9a is arranged on the first side L11 of a second through-hole 9b.

In the present embodiment, the cylindrical rotation member 2 is arranged to project to a second side L12 from the second through-hole 9b. To an end on the second side L12 of the cylindrical rotation member 2, a driving force source D is connected (see FIG. 5).

In the present embodiment, the support member 1 includes a bolt portion 11 and a nut portion 12 that is screwed onto the bolt portion 11. The bolt portion 11 is formed to project to the first side L11 from the first through-hole 9a while a first through-hole forming portion 913 is arranged to come into contact with a stepped surface 1a from the first side L11. The nut portion 12 comes into contact with the first through-hole forming portion 913 from the first side L11 by being screwed onto the bolt portion 11 projecting to the first side L11 from the first through-hole 9a. In this way, the support member 1 is fixed to a case 9.

### 3. Other Embodiments

(1) In the above-described embodiments, a configuration in which the first axial direction L1 is the vertical direction was described as an example. However, without being limited to the configuration, the first axial direction L1 may be a direction that crosses the vertical direction (for example, a horizontal direction).
(2) In the above-described embodiments, a configuration in which the cylindrical rotation member 2 is arranged coaxially with the support member 1 was described as an example. However, without being limited to the configuration, the cylindrical rotation member 2 may be arranged eccentrically with respect to the support member 1.
(3) In the above-described embodiments, a configuration in which the second through-hole 9b is arranged coaxially with the first through-hole 9a was described as an example. However, without being limited to the configuration, in a configuration in which as described above, the cylindrical rotation member 2 is arranged eccentrically with respect to the support member 1, the second through-hole 9b may be arranged eccentrically with respect to the first through-hole 9a.
(4) In the above-described embodiments, a configuration in which the second axis X2 is arranged to be orthogonal to the first axis X1 was described as an example. However, without being limited to the configuration, the second axis X2 may cross the first axis X1 in such a manner as not to be orthogonal to the first axis X1. In addition, the first axis X1 and the second axis X2 may cross each other in such a manner that imaginary extension lines thereof cross each other at one point or may cross each other at different levels.
(5) In the above-described embodiments, a configuration in which the step-up gears 5 include the third gear 51, the fourth gear 52, the fifth gear 53, and the sixth gear 54 and rotation transmitted from the second gear 32 to the third gear 51 is speeded up between the third gear 51 and the fifth gear 53, is also speeded up between the sixth gear 54 and the fourth gear 52, and is transmitted to the rotor 42 was described as an example. However, without being limited to the configuration, the step-up gears 5 may, for example, be formed by a planet gear mechanism.
(6) In the above-described embodiments, a configuration in which the case 9 includes the third housing portion 93 housing the generator 4 was described as an example. However, without being limited to the configuration, it may be configured such that the case 9 does not include the third housing portion 93 and the generator 4 is arranged outside the case 9.
(7) In the above-described embodiment, a configuration in which the support member 1 includes the through-hole 1b that penetrates through the support member 1 in the second axial direction L2 and the transmission shaft 8 is arranged to penetrate through the through-hole 1b was described as an example. However, without being limited to the configuration, it may be configured such that the support member 1 does not include the through-hole 1b and the transmission shaft 8 crosses the support member 1 at different levels.
(8) Note that the configurations disclosed in the respective embodiments described above can be applied in combination with configurations disclosed in the other embodiments as long as no contradiction arises. With regard to the other configurations, the embodiments disclosed herein are described only as examples in all respects. Therefore, various modifications can be made as appropriate without departing from the spirit and scope of the present disclosure.

### INDUSTRIAL APPLICABILITY

The technology according to the present disclosure can be used for a power generation device.

A power generation device according to an aspect of this disclosure includes a columnar support member, a cylindrical rotation member, a first gear, a second gear, a generator, a step-up gear, and a case. An axis of the support member is a first axis. A direction orthogonal to the first axis is defined as a radial direction. The cylindrical rotation member is formed in a cylindrical shape surrounding the support member from an outer side in the radial direction, is supported in a freely rotatable manner with respect to the support member, and rotates by a driving force from a driving force source. The first gear rotates integrally with the cylindrical rotation member. The second gear is supported in a freely rotatable manner about a second axis. The second axis extends along a direction that crosses the first axis. The second gear meshes with the first gear. The step-up gear speeds up rotation of the second gear, and transmits the speeded-up rotation to the generator. The case houses the first gear, the second gear, and the step-up gear. The generator is supported by the case. The case includes a first through-hole through which the support member penetrates and a second through-hole through which the support member and the cylindrical rotation member penetrate. The case is supported by the support member.

According to the above-described power generation device, the first gear, the second gear, and the step-up gear are housed in the case, and the generator is supported by the case. The case is supported by the columnar support member. Since because of this configuration, it is not necessary to install a member to support the first gear, the second gear, the step-up gear, and the generator, separately from the support member, installation area of the power generation device can be easily kept small.

In addition, attaching the case to the support member enables the first gear, the second gear, the step-up gear, and the generator to be supported with respect to the support member. Because of this capability, simplification of installation work of the power generation device can be easily achieved.

In the power generation device described above, a direction along the first axis may be defined as a first axial direction. The support member may include a stepped surface that faces a first side. The first side may be one side in the first axial direction. A portion of the case in which the first through-hole is formed may be arranged to come into contact with the stepped surface from the first side. The support member may be fitted into the first through-hole. A bearing may be arranged between an inner circumferential surface of the second through-hole and an outer circumferential surface of the cylindrical rotation member in the first radial direction.

The power generation device described above may further include an inverter that controls the generator. The generator may include a rotor that is arranged on the second axis. The step-up gear may include a third gear that is arranged on the second axis and to which a driving force from the second gear is transmitted, a fourth gear that rotates integrally with the rotor, a fifth gear that meshes with the third gear, and a sixth gear that rotates integrally with the fifth gear and meshes with the fourth gear. A direction along the second axis may be defined as a second axial direction. The inverter may be arranged to overlap the sixth gear in a second axial direction view along the second axial direction.

The power generation device described above may further include a seventh gear, a transmission shaft, a first one-way clutch, and a second one-way clutch. The seventh gear may be arranged on an opposite side to the second gear with the support member interposed between the seventh gear and the second gear on the second axis, may be supported in a freely rotatable manner about the second axis, and may mesh with the first gear. The transmission shaft may be arranged to penetrate through the second gear and the seventh gear and may be drivingly connected to the step-up gear. One side and the other side of directions of rotation about the second axis may be defined as a first rotational side and a second rotational side, respectively. The first one-way clutch may be arranged between the second gear and the transmission shaft and may allow relative rotation to the first rotational side and may restrict relative rotation to the second rotational side of the second gear with respect to the transmission shaft. The second one-way clutch may be arranged between the seventh gear and the transmission shaft and may allow relative rotation to the first rotational side and may restrict relative rotation to the second rotational side of the seventh gear with respect to the transmission shaft.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A power generation device comprising:
a columnar support member;
a cylindrical rotation member that, with a direction orthogonal to a first axis, the first axis being an axis of the support member, defined as a radial direction, is formed in a cylindrical shape surrounding the support member from an outer side in the radial direction, is supported in a freely rotatable manner with respect to the support member, and rotates by a driving force from a driving force source;
a first gear that rotates integrally with the cylindrical rotation member;
a second gear that is supported in a freely rotatable manner about a second axis, the second axis extending along a direction that crosses the first axis, and meshes with the first gear;
a generator;
a step-up gear that speeds up rotation of the second gear and transmits the speeded-up rotation to the generator; and
a case that houses the first gear, the second gear, and the step-up gear, wherein
the generator is supported by the case, and
the case includes a first through-hole through which the support member penetrates and a second through-hole through which the support member and the cylindrical rotation member penetrate and is supported by the support member.

2. The power generation device according to claim 1, wherein
with a direction along the first axis defined as a first axial direction, the support member includes a stepped surface that faces a first side, the first side being one side in the first axial direction,
a portion of the case in which the first through-hole is formed is arranged to come into contact with the stepped surface from the first side,
the support member is fitted into the first through-hole, and
a bearing is arranged between an inner circumferential surface of the second through-hole and an outer circumferential surface of the cylindrical rotation member in the first radial direction.

3. The power generation device according to claim 1 further comprising
an inverter that controls the generator, wherein
the generator includes a rotor that is arranged on the second axis,
the step-up gear includes a third gear that is arranged on the second axis and to which a driving force from the second gear is transmitted, a fourth gear that rotates integrally with the rotor, a fifth gear that meshes with the third gear, and a sixth gear that rotates integrally with the fifth gear and meshes with the fourth gear, and
with a direction along the second axis defined as a second axial direction, the inverter is arranged to overlap the sixth gear in a second axial direction view along the second axial direction.

4. The power generation device according to claim 2 further comprising
an inverter that controls the generator, wherein
the generator includes a rotor that is arranged on the second axis,
the step-up gear includes a third gear that is arranged on the second axis and to which a driving force from the second gear is transmitted, a fourth gear that rotates integrally with the rotor, a fifth gear that meshes with the third gear, and a sixth gear that rotates integrally with the fifth gear and meshes with the fourth gear, and
with a direction along the second axis defined as a second axial direction, the inverter is arranged to overlap the sixth gear in a second axial direction view along the second axial direction.

5. The power generation device according to claim 1 further comprising:
a seventh gear that is arranged on an opposite side to the second gear with the support member interposed between the seventh gear and the second gear on the second axis, is supported in a freely rotatable manner about the second axis, and meshes with the first gear;
a transmission shaft that is arranged to penetrate through the second gear and the seventh gear and is drivingly connected to the step-up gear;
a first one-way clutch; and
a second one-way clutch, wherein
with one side and the other side of directions of rotation about the second axis defined as a first rotational side and a second rotational side, respectively,
the first one-way clutch is arranged between the second gear and the transmission shaft and allows relative rotation to the first rotational side and restricts relative rotation to the second rotational side of the second gear with respect to the transmission shaft, and
the second one-way clutch is arranged between the seventh gear and the transmission shaft and allows relative rotation to the first rotational side and restricts relative rotation to the second rotational side of the seventh gear with respect to the transmission shaft.

6. The power generation device according to claim 2 further comprising:
a seventh gear that is arranged on an opposite side to the second gear with the support member interposed between the seventh gear and the second gear on the second axis, is supported in a freely rotatable manner about the second axis, and meshes with the first gear;
a transmission shaft that is arranged to penetrate through the second gear and the seventh gear and is drivingly connected to the step-up gear;
a first one-way clutch; and
a second one-way clutch, wherein
with one side and the other side of directions of rotation about the second axis defined as a first rotational side and a second rotational side, respectively,
the first one-way clutch is arranged between the second gear and the transmission shaft and allows relative rotation to the first rotational side and restricts relative rotation to the second rotational side of the second gear with respect to the transmission shaft, and
the second one-way clutch is arranged between the seventh gear and the transmission shaft and allows relative rotation to the first rotational side and restricts relative rotation to the second rotational side of the seventh gear with respect to the transmission shaft.
